(19) United States
(12) Patent Application Publication
(10) Pub. No.: US 2025/0041897 A1
(43) Pub. Date: Feb. 6, 2025

(54) VIRTUAL EMBOSSING ON COIL COATING

(71) Applicant: SWIMC LLC, Cleveland, OH (US)

(72) Inventors: Jose Sergio AVILA SOTO, San Nicolas De Los Garza (MX); Brenda Janeth FERNANDEZ DIAZ, Monterrey (MX)

(21) Appl. No.: 18/717,952

(22) PCT Filed: Dec. 9, 2022
(86) PCT No.: PCT/US2022/081252

§ 371 Date: Jun. 7, 2024

Related U.S. Application Data
(60) Provisional application No. 63/288,064, filed on Dec. 10, 2021.

(51) Int. Cl. B05D 1/28; B05D 3/02; B05D 3/06; B05D 5/06

(52) U.S. Cl. CPC B05D 1/28; B05D 3/0272; B05D 3/067; B05D 5/061; B05D 2601/08

(57) ABSTRACT

The present disclosure provides processes and systems for generating a coated article having a virtual embossing effect. A process comprises applying a wet layer of a coating composition on a substrate, the composition comprising a curable resin and a plurality of flake-form pigments; forming a pattern of the pigments in the wet layer; and curing the wet layer thereby forming a cured layer, wherein the formed pattern of the pigments is capable of remaining substantially unchanged after curing and results in a virtually embossed effect of the cured layer. A coating system comprises a substrate; a coating composition comprising a curable resin and a plurality of flake-forming pigments; means for applying a wet layer of the composition onto the substrate; means for forming a pattern of the pigments in the wet layer; and means for curing the wet layer to form a substantially cured layer. The cured article derived from the processes and systems preferably may have a substantially even surface.

### CROSS-REFERENCE TO RELATED APPLICATION

This application is being filed on Dec. 9, 2022, as a PCT International Patent application and claims the benefit of and priority to U.S. Provisional patent application Ser. No. 63/288,064, filed Dec. 10, 2021, the entire disclosure of which is incorporated by reference herein in its entirety.

### INTRODUCTION

The field of the disclosure generally relates to compositions, systems, and processes regarding the production of virtually embossed surfaces and coated articles comprising a virtually embossed surface.

Structured coatings or surfaces particularly on articles such as a roofing panel, an exterior building covering, an appliance, a component of tractor-trailer equipment, a door, a gutter, a siding panel, a wall covering, a floor covering, or other surfaces for general consumer goods have been known in the art. Such structured coatings or surfaces can provide both decorative and protective functions. They give the said articles an exclusive appearance, which suggests depth and differs from conventional patterns in an advantageous manner.

The substrates and/or the layers comprising structured patterns that contribute to the structural effect are frequently embossed or otherwise structured in order to ultimately have a three-dimensional pattern.

One traditional approach for generating an embossed or three-dimensional pattern is to directly emboss the substrate by mechanical or thermomechanical means to generate a physically deformed surface that demonstrates a structural effect. Such structuring is, however, frequently associated with high equipment complexity, since embossing dies and other complex structuring measures have to be integrated into the process sequence of product production, which is, in particular, then associated with effort and costs if the structured layer is subsequently to be coated further. Furthermore, processes involving embossing substrates permanently deform substrates and may therefore negatively affect the durability and mechanical property of the substrates.

There were also efforts on developing coatings and surfaces having embossing effect without using the traditional substrate-deforming approaches. For example, US 2009/0029054 disclosed a coating system and a method for providing a film having a structured surface and a matte finish. The system includes using a face-side roller on a continuous coating line to impart a structured pattern on a coating surface and a curing step to for hardening the coating layer and permanently retain the pattern on the uppermost surface of the coating layer. The resulted surface is rough and uneven.

U.S. Pat. No. 6,025,024 disclosed a process for generating a structured surface in coil coating comprising: (a) applying a wet layer of a paint on a substrate, the paint having a viscosity of 30 to 200 s and the substrate moving at a speed of at least 60 m/min; (b) passing the wet layer of paint under a roll having a raised pattern on its surface that imparts a structure to the wet layer; then (c) heating the thus coated and rolled substrate to form the structured surface.

However, if the embossed layer is the uppermost layer of the coating, the surface structures, which are often deep, are tactile and can be clearly felt and are thus particularly striking, but on the other hand the recesses formed are exposed to environmental influences, such as dust, other dirt or also mechanical loads, so that the optical appearance and/or the embossed effect may drop significantly in quality in the course of time. Moreover, these physically embossed surfaces are non-virtual and tactile by perception.

Other approaches include the use of pigments capable of forming a pattern or producing a flake-form effect in coating compositions and/or processes. For example, U.S. Pat. No. 4,675,212 discloses a process for the production of decorative coatings in which a plurality of layers are applied one on top of the other. The disclosed process includes the steps of printing a design on a base layer; overlying the printed base layer with a coating of substantially transparent or translucent material; printing a subsequent design using an ink including decorative particles on such transparent or translucent overlying material; and overlaying the ink printed design with a substantially transparent or translucent material prior to subsequent processing, such as heat curing to ensure an effectively fused product of the resulting surface covering. The three-dimensional effect is produced solely by the embossing, while the effect pigments remain oriented parallel to the surface of the product.

GB 2272848 discloses substantially flat surface having a multi-dimensional virtual effect. The disclosed surfaces comprise a plastisol-containing layer, in which flake-form material is uniformly distributed, on a substrate. This layer is partially coated with a further plastisol, which cures and is subsequently pressed into the layer comprising the flake-form material under the action of heat and pressure. In this way, the flake-form pigments present in the underlying layer are rotated out of their parallel orientation and form a spatial pattern. However, the process is tied to the use of plastisol and requires the action of heat and increased pressure in order to emboss the layer comprising the flake-form pigments.

EP 428933 disclosed platelet-shaped pigments that can be used to form a pattern in a coating layer, wherein the coating comprises a different orientation of the pigment particles in defined areas by the pattern. The disclosed process involves the use of magnetically alignable flake-form pigments.

U.S. Pat. No. 8,993,103 disclosed a process for the production of three-dimensional patterns in coatings which comprise flake-form pigments, to patterned coatings produced thereby and to the use thereof in decoration and security products. Particularly, the disclosed process employs a printing plate to impart a pattern on a coating surface and a radiation-based method to cure a coating containing flake-form pigments.

In view of the above disclosures, there remains a desire for a low-cost and manufacturing-feasible process for making coated articles having a virtually embossed surface that have consistent coating quality and appearance, strong mechanical durability, and unique structural pattern and/or three-dimensional effect. It is further desirable for a continuous coil coating system and process to produce in manufacturing scale coil coated articles having a virtually embossed surface.

### Virtual Embossing on Coil Coating

In some aspects, the present disclosure relates to a coating process. The process generally comprises applying a wet layer of a coating composition on a substrate, wherein the composition comprises a curable resin and pigment; forming a pattern of the pigment in the wet layer; and curing the wet layer thereby forming a cured layer, wherein the formed pattern of the pigment is capable of remaining substantially unchanged after curing and results in a virtually embossed effect of the cured layer. In preferred embodiments, the cured layer has a substantially even surface. In some embodiments the pigment incorporates a plurality of flake-form pigments.

In some embodiments, the substrate of the present process comprises a metal substrate. In some embodiments, the substrate further comprises a color basecoat, an intermediate coat, an ink-receptive layer, or combinations thereof. In some embodiments, the present coating composition is an uncured varnish. In some embodiments, the curable resin used herein comprises a polymer selected from a group consisting of polyacrylate, polycarboxylic acids, polyepoxide, polyester, polyurethane, polyester urethane, silicone-polyester, organosol, polyvinylidene fluoride (PVdF) homo- or copolymers, polyvinyl chloride plastisol, or combinations thereof.

In some embodiments, the composition has a solids content from about 20% to about 90%. In some embodiments, the composition has a viscosity from about 1 cP to about 200 cP (1 mPa·s to 200 mPa·s).

In some embodiments, the flake-form pigments are selected from the group of pearlescent pigments, interference pigments, metal-effect pigments, liquid-crystal pigments, flake-form functional pigments, flake-form structured pigments, or a mixture thereof.

In some embodiments, the flake-form pigments are of about 1 to about 35 wt %, based on the total weight of the composition. In some embodiments, the flake-form pigments have an average dimensional size of about 0.01 to about 500 micron (μm). In some embodiments, the flake-form pigments have an average aspect ratio of about 2:1 to about 25,000:1.

In some embodiments, the flake-form pigments are substantially aligned in the wet layer before forming the pattern. In some embodiments, the wet layer has a substantially even surface before curing. In some embodiments, the flake-form pigments in the cured coating are not substantially aligned relative to the moving direction of the substrate.

In some embodiments, the coating composition is capable of keeping the formed pattern of the flake-form pigments therein substantially unchanged prior to curing. In some embodiments, the formed pattern of the flake-form pigments in the wet layer remains substantially unchanged after curing.

In some embodiments, curing the wet layer comprises subjecting the wet layer to electromagnetic radiation. In some embodiments, curing the wet layer comprises heating the wet layer in an oven at a temperature from about 30 to 300° C.

In some embodiments, the cured layer has a thickness of about 0.05 to about 60 micron (μm). In some embodiments, the cured layer has a surface roughness in a range from about 0.5 to about 10 micron (μm).

In some aspects, the present disclosure relates to a coil coating system for making a cured layer having a virtual embossing effect. The coating system comprises a substrate; a coating composition comprising a curable resin and a plurality of flake-forming pigments; means for applying a wet layer of the composition onto the substrate; means for forming a pattern of the pigments in the wet layer; and means for curing the wet layer to form a substantially cured layer, wherein the pattern of the pigments is capable of remaining substantially unchanged after curing and results in a virtual embossing effect of the cured layer. In some embodiments, applying the wet layer and forming a pattern of pigments can be achieved simultaneously or in one single step or by a single means.

In some embodiments, the means for forming the pattern of the pigments comprises at least one face-side rotating roller having a textured surface, wherein the face-side roller is capable of contacting the wet layer that is passing thereunder and imparting the pattern of the pigments in the wet layer.

In some embodiments, the at least one face-side roller is paired with a backing roller, the face-side roller and the backing roller being configured in a nip arrangement wherein the face-side roller is positioned to contact the wet layer while the substrate is carried on the backing roller, the backing roller being moveable with respect to the face-side roller.

In some embodiments, the means for applying the wet layer comprises a coating station for transferring the composition onto the substrate using a coating process selected from the group consisting of slide coating, curtain coating, immersion coating, roll coating, gravure coating, fluid bearing coating and spray coating.

In some embodiments, the means for curing the wet layer is a source of electromagnetic radiation selected from sources of ultraviolet radiation, infrared radiation, X-rays, gamma-rays, visible light and combinations of two or more of the foregoing. In some embodiments, the means for curing the wet layer is a source of heat.

In some embodiments, the coating composition is capable of forming a substantially even surface prior to curing. In some embodiments, the cured layer has a substantially even surface.

In some aspects, the present disclosure relates to a coated article. The coated article may be made by the present coating processes or systems. In some embodiments, the present coated article comprises a substrate; a cured coating layer disposed on the substrate, wherein the cured coating is derived from a coating composition comprising a curable resin and pigment; wherein the pigment forms a pattern in the cured layer that results in a virtually embossed effect. In some embodiments, the pigment is comprised of a plurality of flake-form pigments. In preferred embodiments, the cured layer has a substantially even surface.

In some embodiments, the substrate of the present process comprises a metal substrate. The metal is generally steel, galvanized steel, or aluminum. In other embodiments, the substrate is made of paper, cardboard, wallpaper, a laminate, a tissue material, wood, a polymer, a plastic film, a foil, an engineered material comprising a plurality of the above substances, and where the substrate has optionally been electrostatically pretreated and/or provided with a primer layer and/or another anchoring or receptive layer.

In some embodiments, the cured article is made by a coating process according to the present disclosure. The cured layer has a thickness of about 0.05 to about 500 micron (μm), preferably about 1 to about 100 micron (μm), more preferably about 25 to 60 micron (μm). In some embodiments, the cured layer has a surface roughness in a range from about 0.5 to about 10 micron (μm), preferably about 2 to about 8 micron (μm), more preferably about 3 to about 6 micron (μm).

### Selected Definitions

As used herein, “weight percent,” “wt %,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %,” etc.

As used herein, “g” represents gram; “L” represents liter; “mg” represents “milligram (10⁻³ gram);” “mL” represents milliliter (10⁻³ liter); “cm” represents centimeter (10⁻² meter); micron represents 10⁻⁶ meter; “mm” represents millimeter (10⁻³ meter); “inch” is used as a length unit, and one inch equals to about 2.54 cm; “centipoise” or “cPs” or “CP” is used as a viscosity unit, and 1 cP=10⁻³ Pa·s=1 mPa·s. The temperature unit used herein is degree Celsius (C).

The term “about” is used in conjunction with numeric values to include normal variations in measurements as expected by persons skilled in the art and is understood have the same meaning as “approximately” and to cover a typical margin of error, such as ±10% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

“Face-side roller” means a roller or other instrument(s) that includes a surface that directly contacts the surface of a coated substrate to impart a pattern to the surface of a coat-able or flowable composition. Although the described embodiments utilize an actual roller, a face-side roller may comprise any of a variety of configurations including without limitation a belt mounted on and driven by one or more drive rollers.

The term “polymer” will be understood to include polymers, copolymers (e.g., polymers formed using two or more different monomers), oligomers and combinations thereof. Both block and random copolymers are included, unless indicated otherwise.

The processes, systems, and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed processes and compositions.

### BRIEF DESCRIPTION OF THE DRAWINGS

In describing embodiments of the present disclosure, reference is made to the various Figures in which reference numerals indicate described features of the embodiments and like reference numerals indicate like structures, wherein:

FIG. 1 is a schematic view of an embodiment coating system for generating a surface having a virtual embossing effect according to the present disclosure.

FIG. 2A-2D illustrate a portion of an embodiment of a coating system and delineated steps of the process for forming a pattern of pigments according to the present disclosure.

FIG. 3 is a schematic view of another embodiment coating system for generating a surface having a virtual embossing effect according to the present disclosure.

FIG. 4 illustrates a portion of an embodiment of a coating system for simultaneously applying a wet layer of a coating composition and forming a pattern of pigments therein according to the present disclosure.

FIG. 5 shows photographs of various embodiments of the coated articles derived from the process according to the present disclosure.

### DETAILED DESCRIPTION

The present disclosure provides compositions, systems, and processes related to a coil coated article. The present coating process generally comprises applying a wet layer of a coating composition on a substrate, the composition comprising a curable resin and pigment; forming a pattern of the pigment in the wet layer; and curing the wet layer thereby forming a cured layer, wherein the pattern of the pigment is capable of remaining substantially unchanged after curing and results in a virtually embossed effect of the cured layer. In some embodiments, the pigment comprises a plurality of flake-form pigments. In preferred embodiments, the cured layer has a substantially even surface.

The present process utilizes formulated polymer-based compositions that contain special flake-form pigments. The pigments used herein enable coating to generate and maintain a mark or pattern when applied to a substrate in liquid form and subjected to a pattern-forming step. Further curing on coil lines make mark or pattern permanent in the cured coating.

The present process and coating system offer many advantages. First, the processes described herein can be a continuous coil coating process for massive and efficient production of coated articles. The unique pattern-forming means and step utilized in the present process involve one or more face-side rotating rollers that can contact the uncured coating layer in coil coating line prior to curing and impart a virtual embossing pattern of the pigments so desired in the coating layer. This continuous coil coating process significantly improves the coating consistency along the machine direction of the coil web and the overall production efficiency, compared with the traditional batch process for generating patterns such as using a three-dimensional printing plate or a patterned mask. In addition, various patterns can be imparted into the cured layer by designing the raised pattern or the textured surface of the face-side rollers according to specific consumer needs without incurring significant cost.

Second, the cured article preferably has a substantially even surface, while the formed virtual embossing pattern of the pigments could remain permanent in the cured layer. This unique virtual embossing effect provides a non-tactile and three-dimensional visual sensation to consumers. In some embodiments, the substantially even surface refers to a flat and/or untextured surface finish of the cured layer. Therefore, while the virtual embossing effect gives the perception of three-dimensional features, patters and/or textures, the surface of the cured layer remains substantially flat and not textured. The present surfaces having a virtual embossing effect are aesthetically more attractive and substantially differentiated from the traditional matte-finished or textured or uneven surfaces. In addition, the substantially even surface may extend the coating durability against corrosion or mechanical friction while keeping the virtual embossing pattern intact and prolonging the aesthetical effect, compared with textured surfaces that are not even.

Further, the continuous coil coating system and process described in the present disclosure do not require significant modification of existing coating lines and/or complicated manufacturing equipment and are thereby cost-effective and manufacture-feasible and convenient. Coaters can be enabled to provide embossing patterns without the need for classical embossing equipment that involves substrate deformation.

### Coating Process

In some aspects, the present disclosure relates to a coating process generally comprising applying a wet layer of a coating composition on a substrate, the composition comprising a curable resin and pigment; forming a pattern of the pigment in the wet layer; and curing the wet layer thereby forming a cured layer, wherein the formed pattern of the pigment is capable of remaining substantially unchanged after curing and results in a virtually embossed effect of the cured layer. In some embodiments, the pigment comprises a plurality of flake-form pigments. In preferred embodiments, the cured layer has a substantially even surface.

Coil coating is a continuous coating process of coiled substrates. In some embodiments, the substrate of the present process comprises a metal substrate. The metal is generally steel, galvanized steel, or aluminum. In other embodiments, the substrate is made of paper, cardboard, wallpaper, a laminate, a tissue material, wood, a polymer, a plastic film, a foil, an engineered material comprising a plurality of the above substances, and where the substrate has optionally been electrostatically pretreated and/or provided with a primer layer and/or another anchoring or receptive layer.

In some embodiments, the substrate further comprises a color basecoat, an intermediate coat, an ink-receptive layer, or combinations thereof. The wet layer of the present coating composition is applied to the uppermost surface of the substrate. The color basecoat is a finished coating layer providing various colors as needed and is capable of forming interfacial adhesion to the present coating composition when applied thereon.

In some embodiments, the present coating composition is an uncured varnish. The varnished used herein provides a durable, abrasion resistant, water-resistant, and tough layer once cured. Waterborne varnishes can have very low VOC (volatile organic component) and can be environmentally friendly.

In some embodiments, the curable resin used herein comprises a polymer including but not limited to polyacrylate, polycarboxylic acids, polyepoxide, polyester, polyurethane, polyesterurethane, silicone-polyester, organosol, polyvinylidene fluoride (PVdF) homo- or copolymers, polyvinyl chloride plastisol, or combinations thereof.

A polyester resin that is suitable for purposes of the present disclosure is typically produced by a condensation reaction between polyols, predominantly diols and triols, and polycarboxylic acids or corresponding anhydrides.

Polycarboxylic acids typically used in the condensation reaction to make the polyester resin include, but are not limited to, adipic, methyladipic, malonic, sebacic, suberic, glutaric, fumaric, itaconic, malic, diglycolic, the 1,3- and 1,4-cyclohexanedicarboxylic acids, pimelic, azelaic, 1,12-dodecanedioic, maleic acid, maleic anhydride, succinic acid, succinic anhydride, methylsuccinic and tetrapropenyl succinic acids and their anhydrides, and tetrahydrophthalic anhydride. Combinations of two or more polycarboxylic acids can also be used.

A polyvinylidine diflouride resin that is suitable for purposes of the present disclosure is typically synthesized from a gaseous vinylidine diflouride monomer via a free radical polymerization process. A suitable polyvinylidine diflouride resin for the purposes of this disclosure includes Kynar 500®, commercially available from Arkema Inc. of Philadelphia, Pa.

An acrylic resin that is suitable for purposes of the present disclosure may be derived from acrylic acid. To form the acrylic resin, acrylic acid is typically reacted with an alcohol to form a carboxylic ester. The carboxylic ester may combine with itself or monomers to form the acrylic resin, which may be a homopolymer. Acrylic resins may be used in combination with the resins listed above, for example polyester resins or polyvinylidine resins, in solution to aid in flow of the coating composition.

A siliconized polyester resin that is suitable for purposes of the present disclosure typically includes a silicon-modified polyester resin. A suitable siliconized polyester resin for the purposes of this disclosure is commercially available from BASF Corporation of Florham Park, N.J.

A polyvinyl chloride plastisol resin that is suitable for purposes of the present disclosure is typically a dispersion in plasticizers of fine particle-size polyvinyl chloride.

The curable resin used herein may be present in an amount of from about 20 wt % to about 90 wt %, or from about 30 wt % to about 80 wt %, or from about 40 wt % to about 70 wt %, based on the total weight of the coating composition. The resin used herein is typically film forming and has sufficient flowability and compatibility with the substrate.

In some embodiments, the curable resin comprises a reactive or cross-linkable functionality, such as unsaturated carbon-carbon bond, hydroxyl group, silanol group, amino group, carbonyl group, anhydride group, or other groups that are capable of forming covalent linkage to the curable resin.

In some embodiments, the present coating composition further comprises a curing agent, cross-linker, thermal initiator, photo initiator, catalyst, or combinations thereof. The cross-linker may be reactive with the resin. Such cross-linkers are known in the art, and the specific cross-linker may depend upon the type of resin used. For example, in the embodiment of the coating composition formed from the polyester resin, the cross-linker is typically reactive with active hydrogen atoms in the polyester resin to establish the cured coating.

The present coating composition may also comprise a solvent. The solvent may be any organic solvent known in the art and/or water. The solvent may be present in an amount from about 10 wt % to about 80 wt %, preferably from about 20 wt % to about 70 wt %, and most preferably from about 30 wt % to about 60 wt % based on the total weight of the coating composition.

The present coating composition may also include an additive. Typical additives may be selected from the group of waxes, surfactants, fillers, plasticizers, emulsifiers, texturizers, catalysts, thickeners, adhesion promoters, stabilizers, defoaming agents, wetting additives, coloring agent, leveling agent, and combinations thereof. The additive may be present in an amount of from 1 to 20, preferably from about 1 wt % to about 15 wt %, or from about 3 wt % to about 12 wt %, or from about 5 wt % to about 10 wt %, based on the total weight of the coating composition.

In some embodiments, the pigment used herein is a flake-form pigment. Flake-form pigments which can be employed in the process according to the present disclosure are all known in the art, so long as these are visible in the respective solidified layer. Flake-form pigments of this type are advantageously selected from the group pearlescent pigments, interference pigments, metal-effect pigments, liquid-crystal pigments, flake-form functional pigments, flake-form structured pigments, or a mixture thereof. These flake-form pigments are built up from one or more layers of materials, if desired different materials, and are in flake form.

These pigments preferably have a flake-form support, which optionally comprises at least one coating of a metal, metal oxide, metal oxide hydrate or mixtures thereof, a metal mixed oxide, suboxide or oxynitride, metal fluoride or a polymer.

Pearlescent pigments consist of transparent flakes of high refractive index and exhibit a characteristic pearlescence due to multiple reflection in the case of parallel alignment. Pearlescent pigments of this type which additionally also exhibit interference colors are known as interference pigments.

Although classical pearlescent pigments, such as TiO₂ flakes, basic lead carbonate, BiOCl pigments or nacreous pigments, are naturally also suitable in principle, the flake-form pigments employed for the purposes of the disclosure are preferably flake-form interference pigments or metal-effect pigments, which have at least one coating of a metal, metal oxide, metal oxide hydrate or mixtures thereof, a metal mixed oxide, metal suboxide, metal oxynitride, metal fluoride or a polymer on a flake-form support.

The metal-effect pigments preferably have at least one metal support or a metal coating.

The flake-form support preferably consists of natural or synthetic mica, kaolin or another phyllosilicate, glass, calcium aluminum borosilicate, SiO₂, TiO₂, Al₂O₃, Fe₂O₃, polymer flakes, graphite flakes or metal flakes, such as, for example, of aluminum, titanium, bronze, silver, copper, gold, steel or diverse metal alloys.

Particular preference is given to flake-form supports comprising mica, glass, calcium aluminum borosilicate, graphite, SiO₂, Al₂O₃, or aluminum.

The size of the flake-form support is described herein. The supports generally have a thickness of about 0.01 to about 5 micron, or from about 0.05 to about 3 micron, or from about 0.1 to about 1 micron. The length or width dimension of the pigment used herein is usually from about 0.01 to about 500 microns, or from about 1 to about 200 microns, or from about 5 to about 125 microns. They generally have an aspect ratio (ratio of mean diameter to mean particle thickness) of about 2:1 to about 25,000:1, or from about 3:1 to about 1000:1, or from about 6:1 to about 250:1. Unless otherwise indicated, dimensional size and aspect ratio are with reference to D50 particle size, as determined by standard methods including dynamic light scattering methods, for example. In some embodiments, the flake-form pigments have an average dimensional size of about 0.01 to about 500 microns (μm).

The said dimensions for the flake-form supports in principle also apply to the coated flake-form pigments used in accordance with the present disclosure, since the additional coatings are generally in the region of only a few hundred nanometers and thus do not significantly influence the thickness or length or width (particle size) of the pigments.

A coating applied to the support preferably consists of metals, metal oxides, metal mixed oxides, metal suboxides or metal fluorides and in particular of a colorless or colored metal oxide selected from TiO₂, titanium suboxides, titanium oxynitrides, Fe₂O₃, Fe₃O₄, SnO₂, Sb₂O₃, SiO₂, Al₂O₃, ZrO₂, B₂O₃, Cr₂O₃, ZnO, CuO, NiₓO_{y}, or combinations thereof.

In some embodiments, the pigments used herein may be surface modified to include a reactive surface or a reactive group capable of coupling to the curable resin through covalent bond upon curing. Methods of surface treatment or modification of pigment particles are known in the art.

Effect pigments which can be employed are, for example, the commercially available functional pigments, interference pigments or pearlescent pigments offered by Merck KGaA under the names Iriodin®, Colorstream®, Xirallic®, Miraval®, Ronastar®, Biflair®, Minatec®, Lustrepak®, Colorcrypt®, Colorcode® and Securalic®, Mearlin® from Mearl, metal-effect pigments from Eckart and optically variable effect pigments, such as, for example, Variochrom® from BASF, Chromafflair® from Flex Products Inc., Helicone® from Wacker, holographic pigments from Spectratec and other commercially available effect pigments.

The proportion by weight of the flake-form pigments in the present coating compositions is generally from about 1 wt % to 35 wt %, or from about 5 wt % to about 30 wt %, or from about 10 wt % to about 20 wt %, based on the total weight of the coating composition.

The flake-form pigments can also be employed in a mixture with other non-flake-form pigments so long as the proportion of flake-form effect pigments is sufficiently large that a three-dimensional pattern produced therewith is still visible in the coating. For this purpose, the proportion of flake-form effect pigments in a coating composition comprising them should correspond to at least 30 wt %, or at least 50 wt %, or at least 70 wt % of the total pigment of the coating composition.

In some embodiments, the present composition has a viscosity from about 1 to about 200 cP (about 1 to about 200 mPa·s). The viscosity of the composition can be adjusted to an appropriate level to allow the wet layer after the format-forming step to recover and form a substantially even surface before curing.

In certain embodiments, the present coating compositions have a solids content from about 20% to about 90% by weight of the total coating composition.

The coating composition can be applied continuously on the substrate moving at various speed in a coil coating line, using appropriate coating applications and curing means. The process may further comprise substrate pretreatment (such as degreasing, brushing, rinsing and chemical treatment, as may be required or desired) prior to coating application.

In some embodiments, the coating composition is applied by transferring the composition onto the substrate using a coating process including but not limited to slide coating, curtain coating, immersion coating, roll coating, gravure coating, fluid bearing coating, or spray coating. The wet film usually has a thickness of from about 0.5 to about 60 micron, or from about 5 to about 40 micron, or from about 10 to about 20 micron.

The flake-form pigments in the wet layer of the coating composition are generally oriented substantially parallel to the moving direction of the coated substrate, merely due to the horizontal forces acting during the coating process and due to their flake shape, in order to set the lowest possible resistance to the horizontal flows during the coating process. For this reason, it can be assumed that, in freshly applied coatings which are applied to conventional and virtually flat substrates using conventional coating technologies and comprise flake-form pigments, the pigments are usually aligned substantially parallel to the moving direction of the substrate in the still uncured coating.

In some embodiments, the step of forming the pattern of the flakes comprises passing the still uncured wet layer of the composition under at least one face-side rotating roller, the roller having a textured outer surface, wherein the textured outer surface is positioned to contact with the wet layer and impart the pattern of the flake-form pigments therein. In some embodiments, the at least one face-side roller is paired with a backing roller (also referred to as a back-up roller, the terms being used interchangeably), the face-side roller and the backing roller being configured in a nip arrangement wherein the face-side roller is positioned to contact the wet layer while the substrate is carried on the backing roller, the backing roller being moveable with respect to the face-side roller. The advantages of using a nip arrangement is to more precisely control the contact pressure of the face-side roller applied to the moving substrate and arrive at a pattern of the flake-form pigments so desired.

When the wet layer on a moving web of the substrate is contact against the textured surface of the face-side roller, the textured elements on the roller surface (such as a raised pattern of either regular or irregular shape or configuration) interrupts and penetrates through the surface of the wet layer and induces disorientation of the flake-form pigments such that the pigments are substantially de-aligned and form a pattern corresponding to the raised pattern of the textured surface of the face-side roller. In some embodiments, the flake-form pigments in the wet layer prior to the pattern-forming step exhibit a substantially parallel alignment relative to the moving direction of the substrate, and upon interacting with the face-side roller, change to a de-aligned orientation that is substantially different from the original substantially parallel alignment. Further upon curing, the imparted pattern and/or the de-aligned orientation of the pigments remain permanent in the cured coating, resulting in the virtual embossing and/or three-dimensional effect.

“Substantially parallel alignment” in the sense of the present disclosure is taken to mean both a geometrically parallel alignment of the pigments with the surface of the substrate to be coated and also an alignment with deviations therefrom up to an angle of 25 about 10 degrees, since the technically achievable alignment of effect pigments in coating methods often does not correspond to a strictly geometrically parallel alignment. However, the expression “parallel” is generally used below for “substantially parallel.”

The face-side roller used herein may be selected from any of a variety of rollers made of diverse materials including, without limitation, steel, aluminum, chromed steel, elastomer or elastomer covered rolls such as nitrile rubber surfaced rollers, wood, polymer, ceramic, plastic and the like. In some embodiments, the surface of the face-side rollers includes a design pattern or other identifiable surface feature for imparting a random or non-random pattern and topography onto the pigments of the wet layer coating composition as described above. The diameter of the roll is easily adapted to the linear speed of the coil; the diameter is typically of from 10 to 2000 mm.

Typical dimensions of the raised pattern of the face-side roller are in the range of from 0.2 to 100 mm for the pattern unit and independently from 0.1 to 50 mm for each of the raised and hollow parts of the pattern. The depth of the pattern of the roller surface can be of from 0.01 to 10 mm, depending on the desired structure. The distance between the surface of the raised pattern and the wet layer on the substrate is adapted to the desired depth of the structure, with the usual accuracy required in coil coating.

In some embodiments, the face-side roller may be heated so that the wet layer and the pigments therein are also heated as it contacts the roller. In other embodiments, the face-side roller may be chilled or cooled so that the wet layer is also chilled or cooled as it contacts the surface of the rollers.

In some embodiments, the textured surface of the face-side roller comprises an anti-adhesion topcoat capable of preventing the wet layer on the substrate from substantially transferring onto the face-side roller during the pattern-forming step. The anti-adhesion topcoat may be a fluorine and/or silicone containing coating having low surface energy. The topcoat can be made by coating a topcoat onto the surface or modifying the surface of the roller.

In some embodiments, applying the wet layer and forming the pattern of pigments can be merged in one single step. For example, in a gravure coating set up, the face-side roller can be used as both a transferring and an engraving roller. The coating composition can be transferred directly from an open reservoir containing the coating composition and metered by a doctor blade or alternatively from an intermediate metering/cleaning roller carrying the coating composition. The face-side roller receiving the coating composition is in physical contact with the moving substrate, and simultaneously transfers the coating composition onto the moving substrate and imparts the pattern to the flake-form pigments therein.

The curing step of the present process is well known in the art; more particularly, one of ordinary skill in the art knows how to adapt the curing conditions. In some embodiments, the present process comprises curing the wet layer by a source of electromagnetic radiation selected from sources of ultraviolet radiation, infrared radiation, X-rays, gamma-rays, visible light and combinations of two or more of the foregoing. In other embodiments, the present process comprises curing the wet layer by a source of heat such as passing the coated wet layer and the substrate in a heat oven. In some embodiments, the wet layer is cured at a temperature from 30 to 300° C.

The coated article formed after curing has a cured layer derived from the coating composition. The cured layer is solidified and substantially harder than the wet layer. In preferred embodiments, the cured layer has a substantially even surface. Preferably, the cured layer has a thickness of about 0.05 to about 500 microns (μm), preferably about 1 to about 100 microns (μm), more preferably about 25 to 60 microns (μm). In some embodiments, the cured layer has a thickness of about 0.1 micron to about 60 microns. In some embodiments, the cured layer has a surface roughness in a range from about 0.5 to about 10 micron (μm), preferably about 2 to about 8 micron (μm), more preferably about 3 to about 6 micron (μm). As used herein, the term “surface roughness” refers to the measurement of variations in coating film thickness as measured by a profilometer and reported as average roughness (Ra). Other techniques or methods known to those of skill in the art may also be used to measure surface roughness.

The coated article can then be cut and given its final shape.

Further description of the coil coating process can be found in many textbooks, e.g., in “Organic Coatings: Science and Technology,” Vol. II, pages 290-5, Wicks et al., eds., Wiley, 1994.

### Coating System

In some aspects, the present disclosure relates to a coil coating system for making a cured layer having a virtual embossing effect. The coating system generally comprises a substrate; a coating composition comprising a curable resin and a plurality of flake-forming pigments; means for applying a wet layer of the composition onto the substrate; means for forming a pattern of the pigments in the wet layer; and means for curing the wet layer to form a substantially cured layer, wherein the pattern of the pigments is capable of remaining substantially unchanged after curing and results in a virtual embossed effect of the cured layer. In some embodiments, applying the wet layer and forming a pattern of pigments can be achieved simultaneously in one single step or by a single means.

Referring now to the various Figures, embodiments of the coating systems are shown and will now be described.

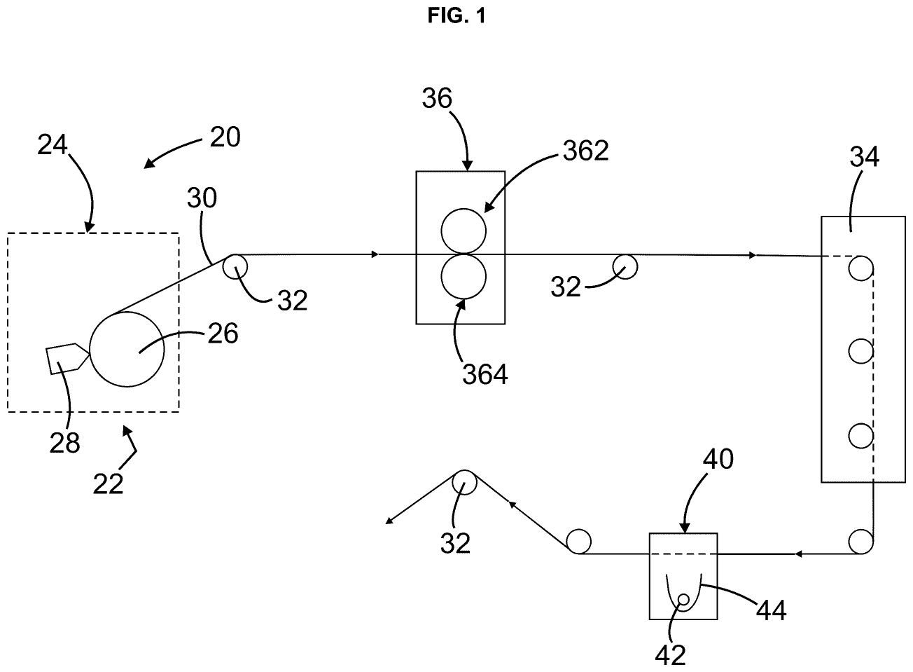

FIG. 1 is a schematic view of one embodiment of a coating system 20 capable of carrying out a manufacturing process for generating a surface having a virtual embossed effect according to the present disclosure. Means for providing a coated substrate encompass a coating process within the system 20. In the depicted embodiment, a coated substrate is manufactured as part of the overall manufacturing process within system 20. Uncoated substrate 22 (e.g., metal coil) is fed into the system 20 from a source (not shown). Substrate 22 is conveyed to a first station 24 in an uncoated state, though it may be primed on at least one surface thereof, and travels to the first station 24 where it is picked up by back-up roller 26 (also referred to as a backing roller), so that a major surface of the substrate 22 is in contact with the back-up roller 26 and the idler rollers 32 to advance the substrate 22 through the system 20. The other major surface of the substrate 22 receives the coating composition to thereby provide a coated substrate 30. Methods of applying the coating composition to the substrate are described elsewhere in the present disclosure.

In some embodiments, means for providing a coated substrate may include a source of a pre-coated substrate comprising a metal substrate and a color basecoat thereon as described herein. The pre-coated substrate may be fed from a feed roll (not shown) directly into the system 20 without requiring an additional coating step via first station 24. In such an embodiment, the pre-coated substrate may be directed into a second station, a third station, or additional optional stations or the like, as described hereinbelow.

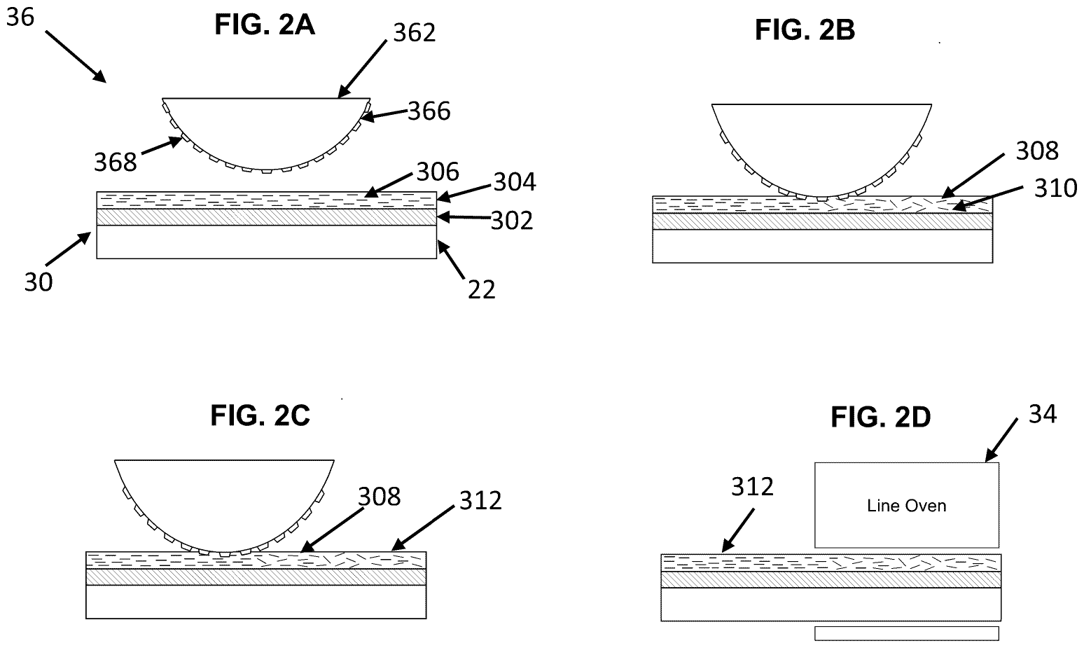

FIG. 2A-2C show the second station 36 which is a coating station for the pattern-forming step. The second station 36 provides a means for forming a pattern of the flake-form pigments in the coated layer prior to curing. The second coating station 36 may comprise a face-side roller 362 and optionally a back-up roller 364 which together with the face-side roller 362 forms a nip arrangement as described before. The face-side roller 362 has a textured surface 366. The textured surface may have a raised pattern 368 in either regular or irregular shape/configuration. The face-side roller 362 is positioned in physical contact with the coated substrate 30. The coated substrate 30 has a substrate 22 such as a metal substrate, a color basecoat 302, and an uncured wet layer 304 of the coating composition, according to the present disclosure. The wet layer 304 further comprises flake-form pigments 306 that are oriented in substantially parallel alignment with the moving direction of the substrate 22. The face-side roller 362 is configured to continuously rotate around a central axis thereof (not shown) and is positioned to directly contact with the wet layer 304 of the coated substrate 30 that is passing by, as shown in FIG. 2B. The raised pattern 368 of the textured surface 366 is capable of penetrating and/or disrupting the wet layer 304 and temporarily form an uneven surface 308 of the wet layer 304. Upon disruption, the flake-form pigments 306 in the wet layer 304 undergo de-alignment and substantially deviate from the original orientation, thereby forming a pattern 310 that contributes to a virtual embossing three-dimensional effect upon curing. The pattern 310 of the flake-form pigments 306 may correspond to the raised pattern 368 or the textured surface 366 of the face-side roller 362 in shape or configuration. However, other parameters such as the composition and viscosity of the wet layer, the physical properties of the pigment particle, the contact pressure of the face-side roller to the wet layer, and the line speed of the coating system may also affect the appearance of the formed pattern 310. The formed pattern 310 of the flake-form pigments may or may not be a mirror image of the raised pattern 368 of the textured surface 366 of the face-side roller 362.

As shown in FIG. 2C, the uneven surface 308 of the wet layer 304 resulting from the disruption by the face-side roller 362 can quickly recover to a substantially even surface 312 before the coated substrate 30 moves into the next station show in FIG. 2D for curing. However, the formed pattern 310 is capable of remaining substantially unchanged within the wet layer 304, regardless of the recovery of the wet layer 304. Thus, the wet layer 304 upon curing retains the formed pattern 310 of the flake-form pigments 306 in the cured layer, which contributes to the virtual embossing and/or three-dimensional effect, while the cured layer remains a substantially even surface 312, as illustrated in FIG. 2D.

The face-side roller 362 may be selected from any of a variety of rollers made of diverse materials including, without limitation, steel, aluminum, chromed steel, elastomer or elastomer covered rolls such as nitrile rubber surfaced rollers, wood, polymer, ceramic, plastic and the like. In some embodiments, the surface of the face-side rollers includes a design pattern or other identifiable surface feature for imparting a random or non-random pattern and topography onto the pigments of the wet layer coating composition as described above. The diameter of the roller 362 is easily adapted to the linear speed of the coil; the diameter is typically of from 10 to 2000 mm.

In some embodiments, the raised pattern 368 of the textured surface 366 may be regular or irregular, and any pattern design may be used. Typical dimensions are in the range of from about 0.2 mm to about 100 mm for the pattern unit and independently from about 0.1 mm to about 50 mm for each of the raised and recessed part of the raised pattern 368. The depth of the pattern 368 of the textured surface 366 can be of from about 0.01 mm to about 10 mm, depending on the desired structure. The distance between the surface of the raised pattern 368 and the wet layer 304 on the substrate is adapted to the desired depth of the structure, with the usual accuracy required in coil coating. Such depth may be controlled to adjust the contact pressure between the roller 362 and the coated substrate 30.

In some embodiments, the face-side roller 362 may be heated so that the wet layer 304 and the pigments 306 therein are also heated as it contacts the face-side roller 362. In other embodiments, the face-side roller 362 may be chilled or cooled so that the wet layer 304 is also chilled or cooled as it contacts the textured surface 366 on the face-side roller 362.

In some embodiments, the textured surface 366 of the face-side roller 362 comprises an anti-adhesion topcoat (not shown) capable of preventing the wet layer on the substrate from substantially transferring onto the face-side roller during the pattern-forming step. The anti-adhesion topcoat may be a fluorine and/or silicone containing coating having low surface energy. The topcoat can be made by coating a topcoat onto the surface or directly modifying the surface of the roller 362.

Referring again to the system 20 of FIGS. 1 and 2D, the coated substrate 30 carrying a formed pattern 310 of the flake-form pigments 306 in the wet layer moves into a third station 34. The third station 34 carries a curing function and provides means for curing and hardening the coated wet layer 304. The means for curing may be provided in the form of a heat source such as an oven, a heating element or the like wherein the wet layer 304 is subjected to elevated temperatures sufficient to drive off solvent and/or at least partially cure at least one component in the wet layer. The exact temperature of the third station 34 will depend, in part, on the composition of the wet layer 304, the desired hardness or degree of cure the wet layer after it exits the third station 34 and the amount of time a coated substrate 30 dwells within the station 34. In some embodiments, the temperature of the oven is from about 30 to about 300° C.

In some embodiments, the coating composition may be a polymerizable or cross-linkable functionality as described, which the polymerization or cross-linking reaction is initiated by the application of electromagnetic radiation. In those embodiments, means for curing the coating composition 304 may comprise a source of electromagnetic radiation, i.e., ultraviolet (UV) radiation, infrared (IR) radiation, X-rays, gamma-rays, visible light or the like. In some embodiments, the means for curing the coating composition comprises an electron beam (e-beam) source and the coating composition is curable or otherwise hardens when exposed to an e-beam. In embodiments of the disclosure wherein the means for curing the coating composition involves temperature control for heating or cooling of coating composition, various mechanisms are contemplated. In some embodiments, the means for curing the coating composition is a temperature-controlled chamber or oven through which the coated substrate passes. In other embodiments, the means for curing the coating composition comprises a temperature-controlled roll that contacts the coated substrate as it advances through the system 20. In some embodiments, means for curing the coating composition comprises a plurality of temperature-controlled rollers. In other embodiments, means for curing the coating composition may comprise a source of temperature-controlled gas. In still other embodiments, means for curing the coating composition comprises temperature-controlled liquid.

In other embodiments, the coating composition may not require either heating or cooling in order to attain an acceptable second viscosity. For some coating composition in some systems, exposure of the coated substrate in air under ambient conditions may be sufficient to harden the coating composition to permit further processing, as described herein.

Referring again to the system 20 of FIG. 1, coated substrate 30 may be conveyed from third station 34 to an optional fourth station 40 where the cured layer is subjected to an additional step of curing or post-curing treatment step. Means for additional curing provided in the fourth station 40 may be similar to or different from the means provided in the third station 34. Additional curing or treatment may increase the degree of curing and further improves the quality and durability of the cured layer. The fourth station 40 is optional in that the coating composition may not require such a treatment.

In the system 20 shown in FIG. 1, the fourth station 40 includes a source 42 which may be a heat source or a source of electromagnetic radiation such as ultraviolet (UV) or infrared (IR) radiation, visible light, X-rays, gamma-rays, e-beam or the like. In some embodiments, the fourth station 40 is an oven capable of thermally curing the coating composition 304. In other embodiments, the fourth station is a radiation source capable of initiating a curing reaction within the coating composition. In still other embodiments, the fourth station 40 may comprise a combination of heat and radiation curing, optionally with forced air drying or other features known to those skilled in the art. In still other embodiments, the fourth station 40 may comprise a plurality of individual stations or a plurality of sources similar or analogous to the source 42. In some embodiments, the fourth station 40 may be configured to apply the same type of treatment applied by third station 34 (e.g., heating or cooling). An optional deflector or shield 44 deflects heat or radiation emitted from the source 42 and directs it toward the coating composition on the coated substrate 30.

Following curing and hardening, the coated substrate 30 may be conveyed to another station (not shown) such as a cutting station to cut the continuous coated substrate into smaller discrete sections. Alternatively, the coated substrate may be directed to a wind-up station where the continuous coated substrate is wound up on a take-up roll, for example. Other process stations (e.g., a packaging station) may be included in the system 20, depending on the use of the final article.

In some embodiments, the entire system 20 or any part or stations thereof may be enclosed or partially enclosed to prevent the coating composition (e.g., varnish) on the substrate or face-side rollers from hardening under ambient light. Such an enclosure may be provided in the form of a shroud constructed to block the transmission of light or other electromagnetic radiation while being transparent enough to facilitate viewing of the process. In some embodiments, the enclosure or shroud may be configured so that it can be purged (e.g., with filtered gas) to further minimize contamination on the face-side roller. Moreover, in systems employing a polymerizable or cross-linkable material as the coating composition, the purge gas is chosen to prevent premature curing. The enclosure may also be equipped to collect volatilized or aerosol dispersed coating material.

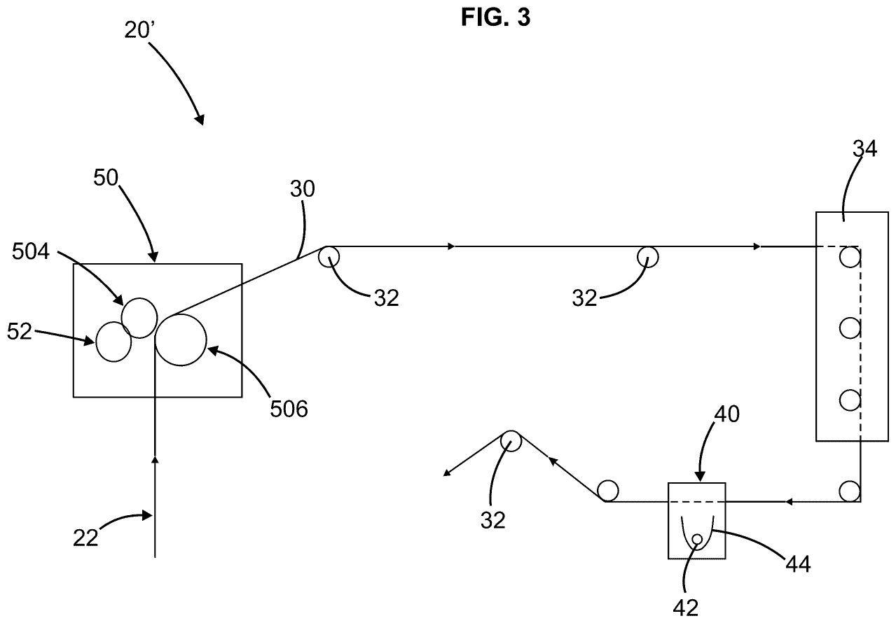

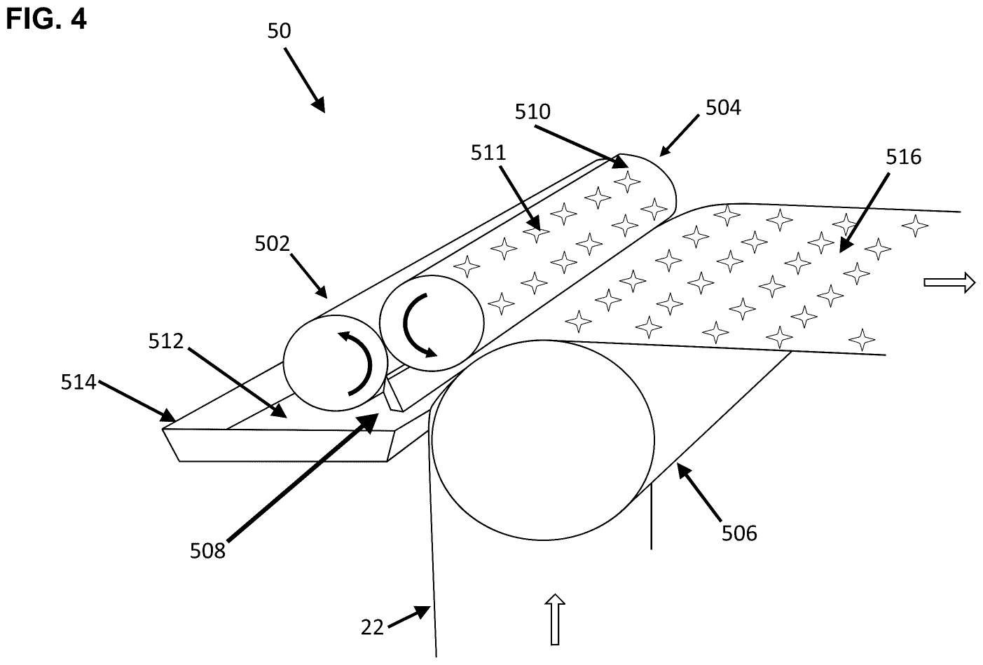

Now referring to FIGS. 3-4, which shows a second embodiment of the coating system 20′ for generating a surface having a virtual embossed effect.

The coating system 20′ is similar to the coating system 20 described above and may comprise any functional part or unit of the coating system 20, except that an integrated station 50 is included in the system 20′ to simultaneously apply a coating composition on the substrate and form a pattern of the flake-form pigments therein in one station. Like the embodiment depicted in the coating system 20, the coating system 20′ may comprise a substrate 22, a station 50 for coating and pattern-forming, and at least one station 34 for curing, and an optional station 40 or optionally other additional stations or the like. Uncoated substrate 22 (e.g., metal coil) is fed into the system 20′ from a source (not shown). Substrate 22 is conveyed to a coating station 50 in an uncoated state, though it may be primed on at least one surface thereof, and travels to the coating station 50 where it is picked up by back-up roller 506 so that a major surface of the substrate 22 is in contact with the back-up roller 506 and the idler rollers 32 to advance the substrate 22 through the system 20′. The other major surface of the substrate 22 receives the coating composition to thereby provide a coated substrate 30.

The coating station 50 as shown in FIG. 4 represents a gravure coating system that includes a metering roller (cleaning roller) 502 used to pick up and receive a coating composition 512 in an open reservoir 514. Coating composition 512 can be any coating composition described according to the present disclosure. A doctor blade 508 is used to doctor off the excessive coating composition on the metering roller 502. The coating composition on the metering roller 502 is then transferred onto a face-side roller 504. Face-side roller 504 can be any face-side roller embodiment described according to the present disclosure. The coating composition 512 comprises a curable resin and a plurality of flake-form pigments as described before. The face-side roller 504 and the back-up roller 506 form a nip arrangement, where the moving uncoated substrate 22 pass through with the other major surface in physical contact with the face-side roller 504. The coating composition on the face-side roller 504 is then transferred onto the substrate 22, forming a wet layer 516 of the coating composition. The face-side roller 504 has a textured surface 510 and a raised pattern 511, according to the present disclosure. When transferring the coating composition 512 onto the substrate 22, the raised pattern 511 simultaneously imparts a pattern of the flake-form pigments contained within the coating composition 512. The coated substrate having the pattern imparted thereon then proceeds to curing. The means and step for curing are discussed elsewhere in the present disclosure.

Additional stations described in the coating system 20′ may also be included in the coating system 20′ when deemed appropriate. Apparently, coating system 20′ advantageously integrates the coating and the pattern-forming steps in one station, thereby improving the coating efficiency and simplifying the coating setup.

### Coated Article

In some aspects, the present disclosure relates to a coated article. The coated article may be made by the present coating processes or systems. In some embodiments, the present coated article comprises a substrate; a cured coating layer disposed on the substrate, wherein the cured coating is derived from a coating composition comprising a curable resin and a plurality of flake-form pigments; wherein the pigments form a pattern in the cured layer that contributes to a virtual embossing effect. In preferred embodiments, the cured layer has a substantially even surface.

In some embodiments, the substrate of the present process comprises a metal substrate. The metal is generally steel, galvanized steel, or aluminum. In other embodiments, the substrate is made of paper, cardboard, wallpaper, a laminate, a tissue material, wood, a polymer, a plastic film, a foil, an engineered material comprising a plurality of the above substances, and where the substrate has optionally been electrostatically pretreated and/or provided with a primer layer and/or another anchoring or receptive layer.

In some embodiments, the substrate further comprises a color basecoat, an intermediate coat, an ink-receptive layer, or combinations thereof. The wet layer of the present coating composition is applied to the uppermost surface of the substrate. The color basecoat is a finished coating layer providing various colors as needed and is capable of forming interfacial adhesion to the present coating composition when applied thereon.

In some embodiments, the present coating composition is an uncured varnish. The varnished used herein provides a durable, abrasion resistant, water-resistant, and tough layer once cured. Waterborne varnishes can have very low VOC (volatile organic component) and can be environmentally friendly.

In some embodiments, the curable resin used herein comprises a polymer including but not limited to polyacrylate, polycarboxylic acids, polyepoxide, polyester, polyurethane, polyesterurethane, silicone-polyester, organosol, polyvinylidene fluoride (PVdF) homo- or copolymers, polyvinyl chloride plastisol, or combinations thereof.

A polyester resin that is suitable for purposes of the present disclosure is typically produced by a condensation reaction between polyols, predominantly diols and triols, and polycarboxylic acids or corresponding anhydrides.

Polycarboxylic acids typically used in the condensation reaction to make the polyester resin include, but are not limited to, adipic, methyladipic, malonic, sebacic, suberic, glutaric, fumaric, itaconic, malic, diglycolic, the 1,3- and 1,4-cyclohexanedicarboxylic acids, pimelic, azelaic, 1,12-dodecanedioic, maleic acid, maleic anhydride, succinic acid, succinic anhydride, methylsuccinic and tetrapropenyl succinic acids and their anhydrides, and tetrahydrophthalic anhydride. Combinations of two or more polycarboxylic acids can also be used.

A polyvinylidine diflouride resin that is suitable for purposes of the present disclosure is typically synthesized from a gaseous vinylidine diflouride monomer via a free radical polymerization process. A suitable polyvinylidine diflouride resin for the purposes of this disclosure includes Kynar 500®, commercially available from Arkema Inc. of Philadelphia, Pa.

An acrylic resin that is suitable for purposes of the present disclosure may be derived from acrylic acid. To form the acrylic resin, acrylic acid is typically reacted with an alcohol to form a carboxylic ester. The carboxylic ester may combine with itself or monomers to form the acrylic resin, which may be a homopolymer. Acrylic resins may be used in combination with the resins listed above, for example polyester resins or polyvinylidine resins, in solution to aid in flow of the coating composition.

A siliconized polyester resin that is suitable for purposes of the present disclosure typically includes a silicon-modified polyester resin. A suitable siliconized polyester resin for the purposes of this disclosure is commercially available from BASF Corporation of Florham Park, N.J.

A polyvinyl chloride plastisol resin that is suitable for purposes of the present disclosure is typically a dispersion in plasticizers of fine particle-size polyvinyl chloride.

The curable resin used herein may be present in an amount of from about 20 wt % to about 90 wt %, or from about 30 wt % to about 80 wt %, or from about 40 wt % to about 70 wt %, based on the total weight of the coating composition. The resin used herein is typically film forming and has sufficient flowability and compatibility with the substrate.

In some embodiments, the curable resin comprises a reactive or cross-linkable functionality, such as unsaturated carbon-carbon bond, hydroxyl group, silanol group, amino group, carbonyl group, anhydride group, or other groups that are capable of forming covalent linkage to the curable resin.

In some embodiments, the present coating composition further comprises a curing agent, cross-linker, thermal initiator, photo initiator, catalyst, or combinations thereof. The cross-linker may be reactive with the resin. Such cross-linkers are known in the art, and the specific cross-linker may depend upon the type of resin used. For example, in the embodiment of the coating composition formed from the polyester resin, the cross-linker is typically reactive with active hydrogen atoms in the polyester resin to establish the cured coating.

The present coating composition may also comprise a solvent. The solvent may be any organic solvent known in the art and/or water. The solvent may be present in an amount from about 10 wt % to about 80 wt %, preferably from about 20 wt % to about 70 wt %, and most preferably from about 30 wt % to about 60 wt % based on the total weight of the coating composition.

The present coating composition may also include an additive. Typical additives may be selected from the group of waxes, surfactants, fillers, plasticizers, emulsifiers, texturizers, catalysts, thickeners, adhesion promoters, stabilizers, defoaming agents, wetting additives, coloring agent, leveling agent, and combinations thereof. The additive may be present in an amount of from 1 to 20, preferably from about 1 wt % to about 15 wt %, or from about 3 wt % to about 12 wt %, or from about 5 wt % to about 10 wt %, based on the total weight of the coating composition.

In some embodiments, the pigment used herein is a flake-form pigment. Flake-form pigments which can be employed in the process according to the present disclosure are all known in the art, so long as these are visible in the respective solidified layer. Flake-form pigments of this type are advantageously selected from the group pearlescent pigments, interference pigments, metal-effect pigments, liquid-crystal pigments, flake-form functional pigments, flake-form structured pigments, or a mixture thereof. These flake-form pigments are built up from one or more layers of materials, if desired different materials, and are in flake form.

These pigments preferably have a flake-form support, which optionally comprises at least one coating of a metal, metal oxide, metal oxide hydrate or mixtures thereof, a metal mixed oxide, suboxide or oxynitride, metal fluoride or a polymer.

Pearlescent pigments consist of transparent flakes of high refractive index and exhibit a characteristic pearlescence due to multiple reflection in the case of parallel alignment. Pearlescent pigments of this type which additionally also exhibit interference colors are known as interference pigments.

Although classical pearlescent pigments, such as TiO₂ flakes, basic lead carbonate, BiOCl pigments or nacreous pigments, are naturally also suitable in principle, the flake-form pigments employed for the purposes of the disclosure are preferably flake-form interference pigments or metal-effect pigments, which have at least one coating of a metal, metal oxide, metal oxide hydrate or mixtures thereof, a metal mixed oxide, metal suboxide, metal oxynitride, metal fluoride or a polymer on a flake-form support.

The metal-effect pigments preferably have at least one metal support or a metal coating.

The flake-form support preferably consists of natural or synthetic mica, kaolin or another phyllosilicate, glass, calcium aluminum borosilicate, SiO₂, TiO₂, Al₂O₃, Fe₂O₃, polymer flakes, graphite flakes or metal flakes, such as, for example, of aluminum, titanium, bronze, silver, copper, gold, steel or diverse metal alloys.

Particular preference is given to flake-form supports comprising mica, glass, calcium aluminum borosilicate, graphite, SiO₂, Al₂O₃, or aluminum.

The size of the flake-form support is described herein. The supports generally have a thickness of about 0.01 to about 5 microns, or from about 0.05 to about 4.5 micron, or from about 0.1 to about 1 micron. The length or width dimension of the pigment used herein is usually from about 1 to about 500 microns, or from about 1 to about 200 micron, or from about 5 to about 125 micron. They generally have an aspect ratio (ratio of mean diameter to mean particle thickness) of about 2:1 to about 25,000:1, or from about 3:1 to about 1000:1, or from about 6:1 to about 250:1.

The said dimensions for the flake-form supports in principle also apply to the coated flake-form pigments used in accordance with the present disclosure, since the additional coatings are generally in the region of only a few hundred nanometers and thus do not significantly influence the thickness or length or width (particle size) of the pigments.

A coating applied to the support preferably consists of metals, metal oxides, metal mixed oxides, metal suboxides or metal fluorides and in particular of a colorless or colored metal oxide selected from TiO₂, titanium suboxides, titanium oxynitrides, Fe₂O₃, Fe₃O₄, SnO₂, Sb₂O₃, SiO₂, Al₂O₃, ZrO₂, B₂O₃, Cr₂O₃, ZnO, CuO, NiₓO_{y}, or combinations thereof.

In some embodiments, the pigments used herein may be surface modified to include a reactive surface or a reactive group capable of coupling to the curable resin through covalent bond upon curing. Methods of surface treatment or modification of pigment particles are known in the art.

Effect pigments which can be employed are, for example, the commercially available functional pigments, interference pigments or pearlescent pigments offered by Merck KGaA under the names Iriodin®, Colorstream®, Xirallic®, Miraval®, Ronastar®, Biflair®, Minatec®, Lustrepak®, Colorcrypt®, Colorcode® and Securalic®, Mearlin® from Mearl, metal-effect pigments from Eckart and optically variable effect pigments, such as, for example, Variochrom® from BASF, Chromafflair® from Flex Products Inc., Helicone® from Wacker, holographic pigments from Spectratec and other commercially available effect pigments.

The proportion by weight of the flake-form pigments in the present coating compositions is generally from about 1 wt % to 35 wt %, or from about 5 wt % to about 30 wt %, or from about 10 wt % to about 20 wt %, based on the total weight of the coating composition.

The flake-form pigments can also be employed in a mixture with other non-flake-form pigments so long as the proportion of flake-form effect pigments is sufficiently large that a three-dimensional pattern produced therewith is still visible in the coating. For this purpose, the proportion of flake-form effect pigments in a coating composition comprising them should correspond to at least 30 wt %, or at least 50 wt %, or at least 70 wt % of the total pigment of the coating composition.

In some embodiments, the present composition has a viscosity from about 1 to about 200 cP. The viscosity of the composition can be adjusted to an appropriate level to allow the wet layer after the format-forming step to recover and form a substantially even surface before curing.

In some embodiments, the cured article is made by a coating process described herein. The coating process comprises applying a wet layer of the coating composition on the substrate; forming a pattern of the flake-form pigments in the wet layer; and curing the wet layer thereby forming a cured layer, wherein the pattern of the pigment flakes is capable of remaining substantially unchanged after curing and contributes to a virtually embossed effect of the cured layer. In some embodiments, the flake-form pigments have a reactive surface or a reactive group capable of forming a covalent bond to the resin upon curing. Mechanisms and means for forming the pattern and the curing the wet layer are discussed elsewhere in the present disclosure.

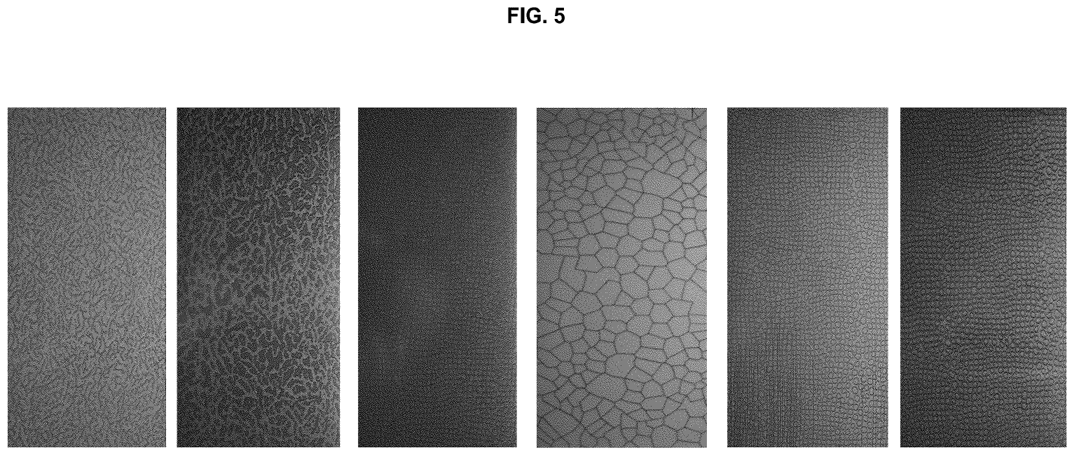

FIG. 5 shows a variety of cured articles having different virtual embossing patterns of the flake-form pigments in the cured layer. The pattern of the cured article may correspond to the textured surface of the side-face roller used to impart the pattern as described in the present disclosure. However, the formed pattern of the pigments may not have to be a mirror image of the raised pattern of the surface texture of the face-side roller.

The cured layer has a thickness of about 0.05 to about 500 microns (μm), preferably about 1 to about 100 microns (μm), more preferably about 25 to 60 micron (μm). In some embodiments, the cured layer has a surface roughness in a range from about 0.5 to about 10 microns (μm), preferably about 2 to about 8 microns (μm), more preferably about 3 to about 6 microns (μm).

The virtual embossing effect is successfully achieved by the change in the optically perceptible effect of the flake-form pigments at the points of the coating which come into contact with the raised pattern or the textured surface of the rotating face-side roller according to the present coating process and are thus de-aligned or deviated from the original substantially parallel alignment. A three-dimensional effect is produced in the coating here and is perceptible via the optical effects rendered visible by the pattern formed by the orientation of the pigments. The visible three-dimensional pattern here is significantly more pronounced than would have been expected from the actual deformation of the coating or an uneven/rough surface, since pattern of the flake-form pigments out of the parallel position, even by only a few angle degrees, already results in a significant change in their reflection properties.

It is possible to achieve visually very attractive results which cannot be obtained with classical organic or inorganic dyes or colored pigments alone. Thus, especially in exterior expression and building aesthetics which exhibit a color play and/or impressive light/dark effects on tilting (optically variable prints) are highly valued. The flake-form pigments employed could exhibit an optically variable effect, if the viewing angle is changed relative to the entire cured layer, but also even on viewing of the coating from a single viewing angle, so that the three-dimensional pattern produced appears in different colors and/or different degrees of brightness.

Although only exemplary embodiments of the present disclosure have been described in detail above, those skilled in the art will readily appreciate that many modifications are possible without materially departing from the novel teachings and advantages of this disclosure. Accordingly, all such modifications are intended to be included within the scope of this disclosure as defined in the following claims.

Embodiments and examples of the present disclosure are further disclosed in the enumerated clauses that follow:
1. A coating process, comprising:
   applying a wet layer of a composition on a substrate, the composition comprising a curable resin and pigment;
   forming a pattern of the pigment in the wet layer; and
curing the wet layer thereby forming a cured layer,
wherein the pattern of the pigment is capable of remaining substantially unchanged after curing and results in a virtually embossed effect of the cured layer.
2. The process of clause 1, wherein the pigment comprises a plurality of flake-form pigments.
3. The process of clause 1 or 2, wherein forming the pattern of the pigment comprises passing the wet layer of the composition under at least one face-side rotating roller, the face-side roller having a textured outer surface, wherein the textured outer surface is positioned to contact the wet layer and impart the pattern of the pigment therein.
4. The process of clauses 3, wherein the at least one face-side roller is paired with a backing roller, the face-side roller and the backing roller being configured in a nip arrangement wherein the face-side roller is positioned to contact the wet layer while the substrate is carried on the backing roller, the backing roller being moveable with respect to the face-side roller.
5. The process of any of clauses 1-4, wherein the cured layer has a substantially even surface.
6. The process of any of clauses 1-5, wherein the substrate comprises a metal substrate.
7. The process of any of clauses 1-6, wherein the substrate comprises a color basecoat, and wherein the wet layer is applied on the color basecoat.
8. The process of any of clauses 1-7, wherein the composition comprises an uncured varnish.
9. The process of any of clauses 1-8, wherein the composition has a viscosity from about 1 cP to about 200 cP.
10. The process of any of clauses 1-9, wherein the curable resin comprises a polymer selected from a group consisting of polyepoxide, polyester, polyurethane, polyesterurethane, silicone-polyester, PVC plastisol, organosol, polyvinylidene fluoride (PVdF) homo- or copolymers, or combinations thereof.
11. The process of any of clauses 1-10, wherein the curable resin comprises a reactive or cross-linkable functionality.
12. The process of any of clauses 1-11, wherein the composition further comprises an additive selected from the group of wax, surfactant, filler, plasticizer, emulsifier, texturizer, thickener, adhesion promoter, stabilizer, defoaming agent, wetting additive, matting agent, coloring agent, leveling agent, solvent, or combinations thereof.
13. The process of any of clauses 1-12, wherein the composition further comprises at least one of a curing agent, cross-linker, thermal initiator, photo initiator, catalyst, or combinations thereof.
14. The process of any of clauses 1-13, wherein the composition has a solids content from about 20% to about 90%.
15. The process of any of clauses 2-14, wherein the flake-form pigments are selected from a group consisting of pearlescent pigments, interference pigments, metal-effect pigments, liquid-crystal pigments, flake-form functional pigments, flake-form structured pigments, or a combination thereof.
16. The process of any of clauses 1-15, wherein the pigment is present in about 1 wt % to about 35 wt %, based on the total weight of the composition.
17. The process of any of clauses 1-16, wherein the pigment comprises a reactive group capable of coupling to the curable resin through covalent bonding upon curing.
18. The process of any of clauses 1-17, wherein the pigment has an average dimensional size of about 0.01 micron to about 500 microns.
19. The process of any of clauses 2-18, wherein the plurality of flake-form pigments are substantially aligned in the wet layer before forming the pattern.
20. The process of any of clauses 1-19, wherein the wet layer has a substantially even surface before curing.
21. The process of any of clauses 2-20, wherein the plurality of the flake-form pigments in the cured layer are not substantially aligned.
22. The process of any of clauses 1-21, wherein curing the wet layer comprises heating the wet layer at a temperature from about 30° C. to about 300° C.
23. The process of any of clauses 1-22, wherein curing the wet layer comprises subjecting the wet layer to electromagnetic radiation.
24. The process of any of clauses 1-23, the cured layer has a thickness of about 0.1 micron to about 60 microns.
25. The process of any of clauses 1-24 is a coil coating process capable of coating continuously.
26. A coated article comprising the cured layer according to any of claims 1-25.
27. A coil coating system comprising:
   a substrate;
   a composition comprising a curable resin and pigment;
   means for applying a wet layer of the composition onto the substrate;
   means for forming a pattern of the pigment in the wet layer; and
   means for curing the wet layer to form a substantially cured layer,
   wherein the pattern of the pigment is capable of remaining substantially unchanged after curing and results in a virtually embossed effect of the cured layer.
28. The coil-coating system of clause 27, wherein the pigment comprises a plurality of flake-form pigments.
29. The coil coating system of clauses 27 or 28, wherein the means for forming the pattern of the pigment comprises at least one face-side rotating roller having a textured surface, wherein the face-side roller is capable of contacting the wet layer that is passing thereunder and imparting the pattern of the pigment in the wet layer.
30. The coil coating system of any of clauses 27-29, wherein the at least one face-side roller is paired with a backing roller, the face-side roller and the backing roller configured in a nip arrangement wherein the face-side roller is positioned to contact the wet layer while the substrate is carried on the backing roller, the backing roller being moveable with respect to the face-side roller.
31. The coil coating system of any of clauses 27-30, wherein the means for applying the wet layer comprises a coating station for transferring the composition onto the substrate using a coating process selected from the group consisting of slide coating, curtain coating, immersion coating, roll coating, gravure coating, fluid bearing coating and spray coating.
32. The coil coating system of any of clauses 27-31, wherein the means for curing the wet layer is a source of electromagnetic radiation selected from sources of ultraviolet radiation, infrared radiation, X-rays, gamma-rays, visible light and combinations of two or more of the foregoing.
33. The coil coating system of any of clauses 27-31, wherein the means for curing the wet layer is a source of heat.
34. The coil coating system of any of clauses 27-33, wherein the cured layer has a substantially even surface.
35. The coil coating system of any of clauses 27-34, wherein the substrate comprises a metal substrate.
36. The coil coating system of any of clauses 27-35, wherein the substrate comprises a color basecoat, and wherein the wet layer is applied on the color basecoat.
37. The coil coating system of any of clauses 27-36, wherein the composition comprises an uncured varnish.
38. The coil coating system of any of clauses 27-37, wherein the composition has a viscosity from about 1 cP to about 200 cP.
39. The coil coating system of any of clauses 27-38, wherein the curable resin comprises a polymer selected from a group consisting of polyepoxide, polyester, polyurethane, polyesterurethane, silicone-polyester, PVC plastisol, organosol, polyvinylidene fluoride (PVdF) homo- or copolymers, or combinations thereof.
40. The coil coating system of any of clauses 27-39, wherein the curable resin comprises a reactive or cross-linkable functionality.
41. The coil coating system of any of clauses 27-40, wherein the composition further comprises an additive selected from the group of wax, surfactant, filler, plasticizer, emulsifier, texturizer, thickener, adhesion promoter, stabilizer, defoaming agent, wetting additive, matting agent, coloring agent, leveling agent, solvent, or combinations thereof.
42. The coil coating system of any of clauses 27-41, wherein the composition further comprises a curing agent, cross-linker, thermal initiator, photo initiator, catalyst, or combinations thereof.
43. The coil coating system of any of clauses 27-42, wherein the composition has a solids content from about 20% to about 90%.
44. The coil coating system of any of clauses 28-43, wherein the plurality of flake-form pigments are selected from the group of pearlescent pigments, interference pigments, metal-effect pigments, liquid-crystal pigments, flake-form functional pigments, flake-form structured pigments, or a mixture thereof.
45. The coil coating system of any of clauses 27-44, wherein the pigment is present in about 1 wt % to about 35 wt %, based on the total weight of the composition.
46. The coil coating system of any of clauses 27-45, wherein the pigment comprises a reactive group capable of coupling to the curable resin through covalent bonding upon curing.
47. The coil coating system of any of clauses 27-46, wherein the pigment has an average dimensional size of about 0.01 micron to about 500 microns.
48. The coil coating system of any of clauses 28-47, wherein the plurality of flake-form pigments are substantially aligned in the wet layer before forming the pattern.
49. The coil coating system of any of clauses 27-48, wherein the wet layer has a substantially even surface before curing.
50. The coil coating system of any of clauses 28-49, wherein the plurality of flake-form pigments in the cured layer are not substantially aligned.
51. The coil coating system of any of clauses 27-50, wherein curing the wet layer comprises heating the wet layer at a temperature from 30° C. to about 300° C.
52. The coil coating system of any of clauses 27-51, wherein the cured layer has a thickness of about 0.1 micron to about 60 microns.
53. A coil coated article comprising:
   a substrate;
   a cured layer disposed on the substrate, wherein the cured layer is derived from a composition comprising a curable resin and pigment;
   wherein the pigment forms a pattern in the cured layer that results in a virtually embossed effect.
54. The coated article of clause 53, wherein the pigment comprises a plurality of flake-form pigments.
55. The coated article of clauses 53 or 54, wherein the cured layer has a substantially even surface.
56. The coated article of any of clauses 53-55, wherein the substrate comprises a metal substrate.
57. The coated article of any of clauses 53-56, wherein the substrate comprises a color basecoat, and wherein a wet layer is applied on the color basecoat.
58. The coated article of any of clauses 53-57, wherein the composition comprises an uncured varnish.
59. The coated article of any of clauses 53-58, wherein the curable resin comprises a polymer selected from a group consisting of polyepoxide, polyester, polyurethane, polyesterurethane, silicone-polyester, PVC plastisol, organosol, polyvinylidene fluoride (PVdF) homo- or copolymers, or combinations thereof.
60. The coated article of any of clauses 53-59, wherein the curable resin comprises a reactive or cross-linkable functionality.
61. The coated article of any of clauses 53-60, wherein the composition further comprises an additive selected from the group of wax, surfactant, filler, plasticizer, emulsifier, texturizer, thickener, adhesion promoter, stabilizer, defoaming agent, wetting additive, matting agent, coloring agent, leveling agent, solvent, or combinations thereof.
62. The coated article of any of clauses 53-61, wherein the composition further comprises a curing agent, cross-linker, thermal initiator, photo initiator, catalyst, or combinations thereof.
63. The coated article of any of clauses 53-62, wherein the composition has a solids content from about 20% to about 90%.
64. The coated article of any of clauses 54-63, wherein the plurality of flake-form pigments are selected from the group of pearlescent pigments, interference pigments, metal-effect pigments, liquid-crystal pigments, flake-form functional pigments, flake-form structured pigments, or a mixture thereof.
65. The coated article of any of clauses 53-64, wherein the pigment is present in about 1 wt % to about 35 wt %, based on the total weight of the composition.
66. The coated article of any of clauses 53-65, wherein the pigment comprises a reactive group capable of coupling to the curable resin through covalent bonding upon curing.
67. The coated article of any of clauses 53-66, wherein the pigment has an average dimensional size of about 0.01 micron to about 500 microns.
68. The coated article of any of clauses 54-67, wherein the plurality of flake-form pigments in the cured layer are not substantially aligned.
69. The coated article of any of clauses 53-68, the cured layer has a thickness of about 0.1 micron to about 60 microns.

1. A coating process, comprising:
applying a wet layer of a composition on a substrate, the composition comprising a curable resin and pigment;
forming a pattern of the pigment in the wet layer; and
curing the wet layer thereby forming a cured layer,
wherein the pattern of the pigment is capable of remaining substantially unchanged after curing and results in a virtually embossed effect of the cured layer.

2. The process of claim 1, wherein the pigment comprises a plurality of flake-form pigments.

3. The process of claim 1, wherein forming the pattern of the pigment comprises passing the wet layer of the composition under at least one face-side rotating roller, the face-side roller having a textured outer surface, wherein the textured outer surface is positioned to contact the wet layer and impart the pattern of the pigment therein.

4. The process of claim 1, wherein the cured layer has a substantially even surface.

5. The process of claim 1, wherein the composition has a viscosity from about 1 cP to about 200 cP.

6. The process of claim 1, wherein the curable resin comprises a polymer selected from a group consisting of polyepoxide, polyester, polyurethane, polyesterurethane, silicone-polyester, PVC plastisol, organosol, polyvinylidene fluoride (PVdF) homo- or copolymers, or combinations thereof.

7. The process of claim 1, wherein the composition has a solids content from about 20% to about 90%.

8. The process of claim 1, wherein the flake-form pigments are selected from a group consisting of pearlescent pigments, interference pigments, metal-effect pigments, liquid-crystal pigments, flake-form functional pigments, flake-form structured pigments, or a combination thereof.

9. A coated article comprising the cured layer according to claim 1.

10. A coil coating system comprising:
a substrate;
a composition comprising a curable resin and pigment;
means for applying a wet layer of the composition onto the substrate;
means for forming a pattern of the pigment in the wet layer; and
means for curing the wet layer to form a substantially cured layer,
wherein the pattern of the pigment is capable of remaining substantially unchanged after curing and results in a virtually embossed effect of the cured layer.

11. The coil-coating system of claim 10, wherein the pigment comprises a plurality of flake-form pigments.

12. The coil coating system of claim 10, wherein the means for forming the pattern of the pigment comprises at least one face-side rotating roller having a textured surface, wherein the face-side roller is capable of contacting the wet layer that is passing thereunder and imparting the pattern of the pigment in the wet layer.

13. The coil coating system of claim 10, wherein the means for applying the wet layer comprises a coating station for transferring the composition onto the substrate using a coating process selected from the group consisting of slide coating, curtain coating, immersion coating, roll coating, gravure coating, fluid bearing coating and spray coating.

14. The coil coating system of claim 10, wherein the means for curing the wet layer is a source of electromagnetic radiation selected from sources of ultraviolet radiation, infrared radiation, X-rays, gamma-rays, visible light and combinations of two or more of the foregoing.

15. The coil coating system of claim 10, wherein the cured layer has a substantially even surface.

16. The coil coating system of claim 10, wherein the composition comprises an uncured varnish.

17. The coil coating system of claim 10, wherein the pigment is present in about 1 wt % to about 35 wt %, based on the total weight of the composition.

18. A coil coated article comprising:
a substrate;
a cured layer disposed on the substrate, wherein the cured layer is derived from a composition comprising a curable resin and pigment;
wherein the pigment forms a pattern in the cured layer that results in a virtually embossed effect.

19. The coated article of claim 18, wherein the pigment comprises a plurality of flake-form pigments.

20. The coated article of claim 18, the cured layer has a thickness of about 0.1 micron to about 60 microns.
